(19) United States
(12) Patent Application Publication
(10) Pub. No.: US 2017/0349471 A1
(43) Pub. Date: Dec. 7, 2017

(54) METHODS AND APPARATUSES INCLUDING EDGE DIRECTORS FOR FORMING GLASS RIBBONS

(71) Applicant: Corning Incorporated, Corning, NY (US)

(72) Inventors: Olus Naili Boratav, Ithaca, NY (US); Steven Roy Burdette, Big Flats, NY (US); Gaozhu Peng, Horseheads, NY (US); William Anthony Whedon, Corning, NY (US)

(21) Appl. No.: 15/609,411

(22) Filed: May 31, 2017

Related U.S. Application Data
(60) Provisional application No. 62/344,767, filed on Jun. 2, 2016.
(60) Provisional application No. 62/478,670, filed on Mar. 30, 2017.

(51) Int. Cl. C03B 17/06

(52) U.S. Cl. CPC C03B 17/064

(57) ABSTRACT

An apparatus for downwardly drawing a glass ribbon includes a forming vessel including an upper portion including a pair of outside surfaces and a forming wedge portion including a pair of downwardly inclined forming surfaces converging along a downstream direction to form a bottom edge. An edge director is provided that includes a flow blocking portion. In some embodiments, the edge director also includes a flow directing portion.

### CROSS-REFERENCE TO RELATED APPLICATIONS

This application claims the benefit of priority under 35 U.S.C. §119 of U.S. Provisional Application Ser. No. 62/478,670 filed on Mar. 30, 2017 and Provisional Application Ser. No. 62/344,767 filed on Jun. 2, 2016 the contents of which are relied upon and incorporated herein by reference in their entirety as if fully set forth below.

### BACKGROUND

### Field

The present specification generally relates to methods and apparatuses for making glass ribbons and, in particular, methods and apparatuses including edge directors for forming glass ribbons.

### Technical Background

Glass forming apparatuses are commonly used to form various glass products such as glass sheets used for LCD displays and the like. These glass sheets may be manufactured by downwardly flowing molten glass over a forming wedge to form a continuous glass ribbon, referred to as a fusion process. In the past, fusion processes have used an edge director. The primary purpose of the edge director is to increase the overall width of glass sheets. Generally the upper limit of sheet width is limited by the “dam-to-dam” distance on the vertical section of a forming vessel. In the absence of any type of edge director on the forming vessel “root” section, the four edges of the two opposing glass layers tend to flow toward the center of the forming vessel while each layer as a whole flows toward the root line where the two sides fuse together. The maximum width of a sheet that would result from this scenario would be reduced.

Current edge directors may reduce some of this width loss of glass sheets, but while doing so, may create a Y-shaped edge that requires the use of edge rolls to press-fuse prongs of the Y together. Any asymmetry of the Y shape that develops over time can lead to air-holes in the edges, so called hollow edges. Both hollow edges and edge asymmetry can present ribbon stability issues and limit the life of the fusion draw apparatus.

### SUMMARY

According to one embodiment, an apparatus for downwardly drawing a glass ribbon comprising: a forming vessel comprising: an upper portion including a pair of outside surfaces; and a forming wedge portion including a pair of downwardly inclined forming surfaces converging along a downstream direction to form a bottom edge; and an edge director comprising a flow blocking portion including an upper portion extending along one of the pair of outside surfaces and a lower portion that extends along one of the pair of downwardly inclined forming surfaces and is negatively inclined relative to vertical, the lower portion of the flow blocking portion extending outwardly and downwardly from the upper portion of the flow blocking portion toward the bottom edge.

In another embodiment, an apparatus for downwardly drawing a glass ribbon comprising: a forming vessel comprising: an upper portion including a pair of outside surfaces; and a forming wedge portion including a pair of downwardly inclined forming surfaces converging along a downstream direction to form a bottom edge; and a first edge director comprising a first flow blocking portion; and a second edge director located at an opposite side of the forming vessel from the first edge director, the second edge director comprising a second flow blocking portion; wherein a horizontal distance between the first edge director and the second edge director increases along a height of the forming wedge portion toward the bottom edge.

In yet another embodiment, a method of making a glass ribbon comprising: flowing molten glass over an upper portion of a forming vessel including a pair of outside surfaces and a forming wedge portion including a pair of downwardly inclined forming surface portions that converge along a downstream direction to form a bottom edge; flowing the molten glass over an edge director intersecting with at least one of the pair of outside surfaces and at least one of the pair of downwardly inclined forming surface portions, the edge director comprising a flow blocking portion including an upper portion that extends along one of the pair of vertical surfaces and a lower portion that extends along one of the pair of downwardly inclined forming surfaces and is negatively inclined relative to vertical, the lower portion extending downwardly from the upper portion toward the bottom edge; and drawing the molten glass from the bottom edge of the forming wedge portion to form the glass ribbon.

In yet another embodiment, an apparatus for downwardly drawing a glass ribbon comprising: a forming vessel including a pair of downwardly inclined forming surface portions converging along a downstream direction to form a bottom edge; and an edge director comprising a flow blocking portion that extends outwardly from at least one of the downwardly inclined surface portions and a flow directing portion that engages both the flow blocking portion and the at least one of the downwardly inclined surface portions; wherein a cross-flow direction angle of the flow directing portion is provided a constant preselected angle α to the flow blocking portion between about 95 degrees and about 105 degrees to provide a planar flow directing portion.

In yet another embodiment, an apparatus for downwardly drawing a glass ribbon comprising: a forming wedge portion including a pair of downwardly inclined forming surface portions converging along a downstream direction to form a bottom edge; and an edge director comprising a flow blocking portion that extends outwardly from the pair of downwardly inclined surface portions and a first planar flow directing portion that intersects both the flow blocking portion and one of the pair of downwardly inclined surface portions and a second planar flow directing portion that intersects both the flow blocking portion and the other of the downwardly inclined surface portions; wherein the first planar flow directing portion intersects the second planar flow directing portion at an immersion edge below the bottom edge.

In yet another embodiment, a method of making a glass ribbon comprising: flowing molten glass over a pair of downwardly inclined forming surface portions of a forming vessel, the pair of downwardly inclined forming surface portions converging along a downstream direction to form a bottom edge; flowing the molten glass over an edge director intersecting with at least one of the pair of downwardly inclined forming surface portions, the edge director comprising: a flow blocking portion that extends outwardly from the at least one of the downwardly inclined surface portions and a flow directing portion that intersects both the flow directing portion and the at least one of the downwardly inclined surface portions; wherein a cross-flow direction angle of the flow directing portion is provided a constant preselected angle α to the flow blocking portion between about 95 degrees and about 105 degrees; and drawing the molten glass from the bottom edge of the forming wedge to form the glass ribbon.

Additional features and advantages of the methods and apparatuses for forming glass ribbons will be set forth in the detailed description which follows, and in part will be readily apparent to those skilled in the art from that description or recognized by practicing the embodiments described herein, including the detailed description which follows the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, ad together with the description serve to explain the principles and operations of the claimed subject matter.

### BRIEF DESCRIPTION OF THE DRAWINGS

FIG. 1 schematically depicts an apparatus for forming a glass ribbon according to one or more embodiments shown and described herein;

FIG. 2 schematically depicts a cross sectional perspective view along line 2-2 of FIG. 1;

FIG. 3 is a side, perspective view of an edge director for use with the apparatus of FIG. 1, according to one or more embodiments shown and described herein;

FIG. 4 is a side view of the edge director of FIG. 3;

FIG. 5 is another side, perspective view of the edge director of FIG. 3;

FIG. 6 is a top view of the edge director of FIG. 3;

FIG. 7 is a schematic, section view of the edge director connecting to a forming wedge along line 7-7 of FIG. 2;

FIG. 8 is a schematic, front view of another embodiment of an edge director according to one or more embodiments shown and described herein;

FIG. 9 is a side view of the edge director of FIG. 8;

FIG. 10 is a bottom view of the edge director of FIG. 8;

FIG. 11 is a schematic, front view of another embodiment of an edge director according to one or more embodiments shown and described herein;

FIG. 12 is a side view of the edge director of FIG. 11;

FIG. 13 is a bottom view of the edge director of FIG. 11;

FIG. 14 is a schematic, front view of another embodiment of an edge director according to one or more embodiments shown and described herein;

FIG. 15 is a side view of the edge director of FIG. 14;

FIG. 16 is a bottom view of the edge director of FIG. 14;

FIG. 17 is a schematic, front view of another embodiment of an edge director according to one or more embodiments shown and described herein;

FIG. 18 is a side view of the edge director of FIG. 17;

FIG. 19 is a bottom view of the edge director of FIG. 17;

FIG. 20 is a horizontal view of a glass ribbon edge at a location below an edge director, such as the edge director of FIGS. 8-10, with a line of sight contained in the draw plane illustrating operation of the edge director using an oil that is used to simulate glass flow during a down draw process;

FIG. 21 is a schematic, perspective view of another embodiment of an edge director according to one or more embodiments shown and described herein;

FIG. 22 is a front view of the edge director of FIG. 21;

FIG. 23 is a schematic, perspective view of another embodiment of an edge director according to one or more embodiments shown and described herein;

FIG. 24 is a front view of the edge director of FIG. 23;

FIG. 25 illustrates an end view of another embodiment of an edge director according to one or more embodiments shown and described herein;

FIG. 26 is a schematic illustration of edges of glass flows using various edge directors according to one or more embodiments shown and described herein; and

FIG. 27 is a chart of normalized mass flow versus distance from outer edge of a glass ribbon using an edge director having positive and negative inclination according to one or more embodiments shown and described herein.

### DETAILED DESCRIPTION

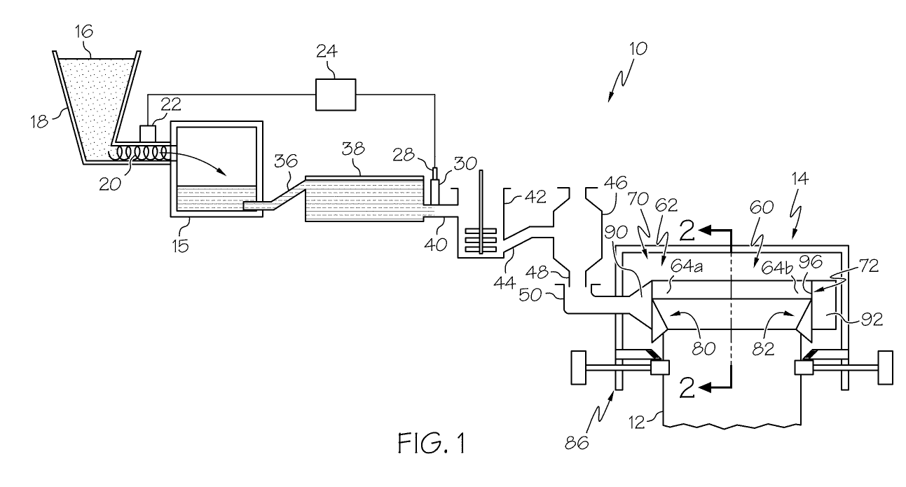

Reference will now be made in detail to embodiments of the methods and apparatuses for forming glass ribbons and edge directors for use with the same, examples of which are illustrated in the accompanying drawings. One embodiment of an apparatus for making glass ribbons is shown in FIG. 1, and is designated generally throughout by the reference number 10. The apparatus 10 generally includes a pair of opposing edge directors located at opposite ends of a forming vessel. As will be described in greater detail below, the edge directors are configured to reduce width loss of the glass ribbon during the forming process. Various embodiments of methods and apparatuses for forming glass ribbons and edge directors for use with the same will be described in further detail herein with specific reference to the appended drawings.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

Referring now to FIG. 1, one embodiment of a glass forming apparatus 10 for forming a glass ribbon 12 is schematically depicted. The glass forming apparatus 10 generally includes a melting vessel 15 configured to receive batch material 16 used to form glass from a storage bin 18. The batch material 16 can be introduced to the melting vessel 15 by a batch delivery device 20 powered by a motor 22. An optional controller 24 may be provided to activate the motor 22 and a molten glass level probe 28 can be used to measure the glass melt level within a standpipe 30 and communicate the measured information to the controller 24.

The glass forming apparatus 10 includes a fining vessel 38 located downstream from the melting vessel 15 and coupled to the melting vessel 15 by way of a first connecting tube 36. A mixing vessel 42 is located downstream from the fining vessel 38. A delivery vessel 46 may be located downstream from the mixing vessel 42. As depicted, a second connecting tube 40 couples the fining vessel 38 to the mixing vessel 42 and a third connecting tube 44 couples the mixing vessel 42 to the delivery vessel 46. As further illustrated, a downcomer 48 is positioned to deliver glass melt from the delivery vessel 46 to an inlet 50 of a forming vessel 60.

The melting vessel 15 is typically made from a refractory material, such as refractory (e.g., ceramic) brick. The glass forming apparatus 10 may further include components that are typically made from platinum or platinum-containing metals such as platinum-rhodium, platinum-iridium and combinations thereof, but which may also comprise such refractory materials such as molybdenum, palladium, rhenium, tantalum, titanium, tungsten, ruthenium, osmium, zirconium, and alloys thereof and/or zirconium dioxide. The platinum-containing components can include one or more of the first connecting tube 36, the fining vessel 38, the second connecting tube 40, the standpipe 30, the mixing vessel 42, the third connecting tube 44, the delivery vessel 46, the downcomer 48 and the inlet 50. The forming vessel 60 can also be made from a refractory material and is designed to form the glass melt into a glass ribbon 12.

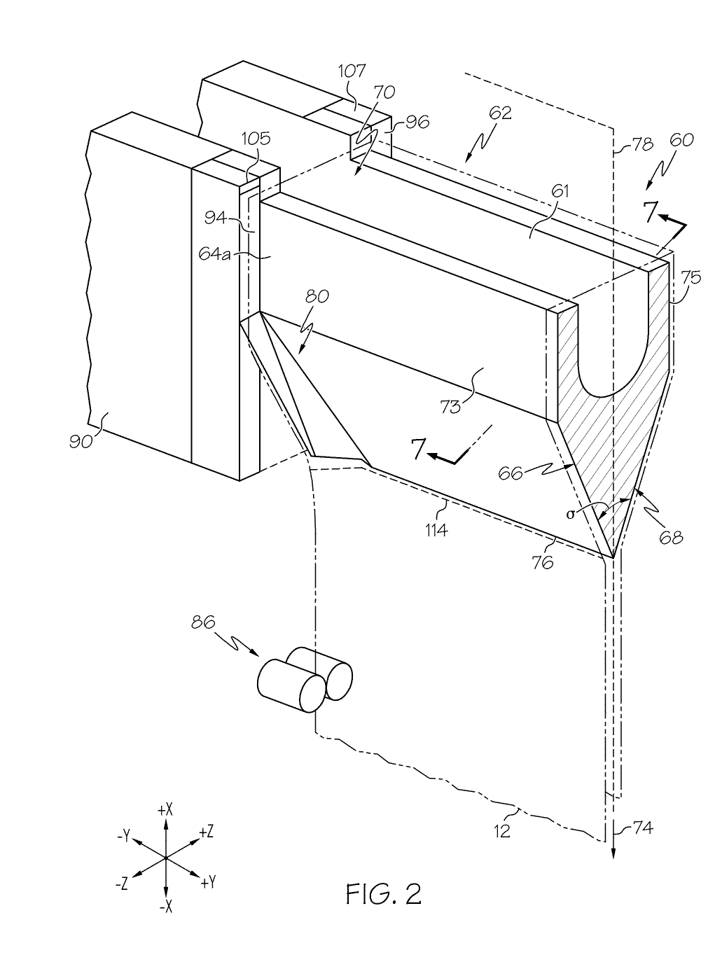

FIG. 2 is a cross sectional perspective view of the glass forming apparatus 10 along line 2-2 of FIG. 1. As shown, the forming vessel 60 includes a forming wedge portion 62 and an open upper portion 61. The upper portion 61 includes parallel outside surface portions 73, 75, and the forming wedge portion 62 includes a pair of downwardly (i.e., in the −x direction of the coordinate axes depicted in FIG. 2) inclined forming surface portions 66, 68 that extend between opposite ends 70, 72 of the forming vessel 60. The downwardly inclined forming surface portions 66, 68 converge along a downstream direction 74 to form a bottom edge or root 76. The root 76 is a boundary where the downwardly inclined forming surface portions 66 and 68 meet or converge. A draw plane 78 extends through the root 76. The glass ribbon 12 may be drawn from the forming wedge portion 62 in the downstream direction 74 along the draw plane 78. As depicted, the draw plane 78 bisects an angle σ formed between inclined forming surface portions 66 and 68 and extends through the root 76. However, it should be understood that the draw plane 78 may extend at other various orientations with respect to the root 76 other than bisecting the angle σ. While FIGS. 1 and 2 generally depict one embodiment of a glass forming apparatus and a forming vessel, it should also be understood that aspects of the present disclosure may be used with various other forming vessel configurations.

Referring to FIGS. 1 and 2, in some embodiments, each opposed end 70, 72 of the forming vessel 60 can be provided with retaining blocks 90 and 92. Vertically-oriented, planar surfaces 94 and 96 are provided that intersect both of the parallel outside surface portions 73, 75 and the downwardly inclined forming surface portions 66, 68. The respective surfaces 94, 96 (FIG. 2) can serve as vertical support surfaces for edge directors 80 and 82 that provide lateral barriers on opposite sides of the glass ribbon 12. The surfaces 94 and 96 with edge directors 80 and 82 are used in limiting migration of the glass ribbon and directing the glass ribbon downwardly toward the root 76. As can be seen particularly by FIG. 2, the surfaces 94 and 96 may extend the entire height or even beyond the entire height of the forming wedge portion 62 (i.e., extend beyond both the root 76 and the upper portion 61 in the +/−x directions).

The forming vessel 60 includes the pair of edge directors 80 and 82 intersecting with the outside surface portions 73 and 75 and the pair of downwardly inclined forming surface portions 66, 68. The edge directors 80, 82 help achieve a desired glass ribbon width and edge characteristics by directing the molten glass proximate to the root 76 of the forming vessel 60. In further embodiments, the edge directors 80 and 82 can intersect with both downwardly inclined forming surface portions 66, 68. In addition, the edge directors 80, 82 can be positioned at each of the opposite ends 70, 72 of the forming wedge portion 62. For instance, as shown in FIG. 1, the edge director 80, 82 can be positioned at each of the opposite ends 70, 72 of the forming wedge portion 62 with each edge director 80, 82 configured to intersect with both of the downwardly inclined forming surface portions 66, 68. The edge directors 80 and 82 also extend vertically along respective surfaces 94 and 96 forming dams. Each edge director 80, 82 may be substantially identical to one another. However, it should be understood that, in alternative embodiments, the edge directors 80, 82 may have different configurations and/or geometries depending on the specific characteristics of the glass forming apparatus. The edge directors 80 and 82 will be described in greater detail below.

Still referring to FIG. 1, the glass forming apparatus 10 can optionally include at least one edge roller assembly 86 for drawing glass ribbon from the root 76 of the forming vessel 60. It should be understood that various edge roller assembly configurations may be used in accordance with aspects of the present disclosure.

A housing 14 encloses the forming vessel 60. The housing 14 may be formed from steel and contain refractory material and/or insulation to thermally insulate the forming vessel 60, and the molten glass flowing in and around the forming vessel 60, from the surrounding environment.

Referring again to FIGS. 1 and 2, in operation, batch material 16, specifically batch material for forming glass, is fed from the storage bin 18 into the melting vessel 15 with the batch delivery device 20. The batch material 16 is melted into molten glass in the melting vessel 15. The molten glass passes from the melting vessel 15 into the fining vessel 38 through the first connecting tube 36. Dissolved gasses, which may result in glass defects, are removed from the molten glass in the fining vessel 38. The molten glass then passes from the fining vessel 38 into the mixing vessel 42 through the second connecting tube 40. The mixing vessel 42 homogenizes the molten glass, such as by stirring, and the homogenized molten glass passes through the third connecting tube 44 to the delivery vessel 46. The delivery vessel 46 discharges the homogenized molten glass through downcomer 48 and into the inlet 50 which, in turn, passes the homogenized molten glass into the upper portion 61 of the forming vessel 60.

As molten glass 17 fills the upwardly open upper portion 61 of forming vessel 60, it overflows the upper portion 61 and flows over the inclined forming surface portions 66, 68 and rejoins at the root 76 of the forming wedge portion 62, thereby forming a glass ribbon 12. As depicted in FIG. 2, the glass ribbon 12 may be drawn in the downstream direction 74 along the draw plane 78 that extends through the root 76.

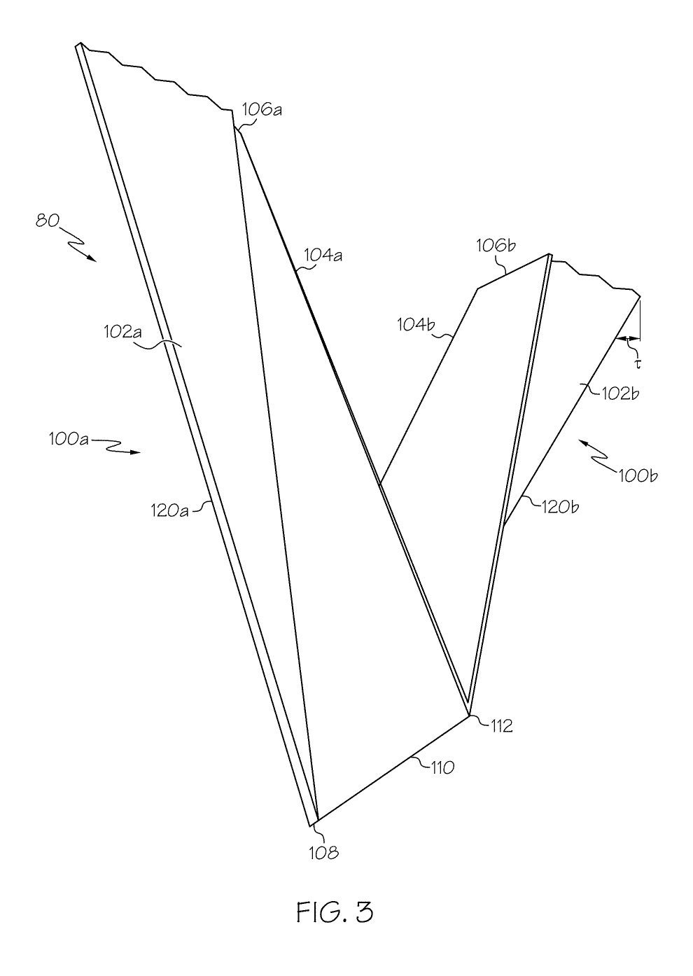

Referring now to FIG. 3, the edge director 80 is illustrated in isolation and generally includes connected edge director portions 100a and 100b. Referring first to edge director portion 100a, the edge director portion 100a includes a flow blocking portion 102a (sometimes referred to as a dam) and a flow directing portion 104a that is connected to the flow blocking portion 102a (e.g., by welding). The flow blocking portion 102a is generally planar and is shaped to extend alongside the surface 94 of the retaining block 90. While only a portion of a height of the flow blocking portion 102a is illustrated by FIG. 3, the flow blocking portion 102a may extend to or even beyond a top 105 of the surface 94 (FIG. 2). The flow directing portion 104a extends outwardly from the flow blocking portion 102a and generally toward the downwardly inclined forming surface portion 66. The flow directing portion 104a can extend outwardly from the flow directing portion 104a in an increasing fashion from a top 106a of the flow directing portion 104a toward a bottom 108 of the flow blocking portion 102a thereby forming a ramped flow directing portion 104a of increasing length that increases in a direction outward from the flow blocking portion 102a from the top 106a to the bottom 108.

Similarly, the edge director portion 100b includes a flow blocking portion 102b and a flow directing portion 104b. The flow blocking portion 102b is generally planar and is shaped to extend alongside the planar surface 94 of the retaining block 90. Again, while only a portion of a height of the flow blocking portion 102b is illustrated by FIG. 3, the flow blocking portion 102a may extend to or even beyond a top 107 of the surface 96 (FIG. 2). The flow directing portion 104b extends outwardly from the flow blocking portion 102b and generally toward the downwardly inclined forming surface portion 66. The flow directing portion 104b can extend outwardly from the flow blocking portion 102b in an increasing fashion from a top 106b of the flow directing portion 104b toward the bottom 108 of the flow blocking portion 102b thereby forming a ramped flow directing portion 104b of increasing length that increases in a direction outward from the flow blocking portion 102b from the top 106a to the bottom 108.

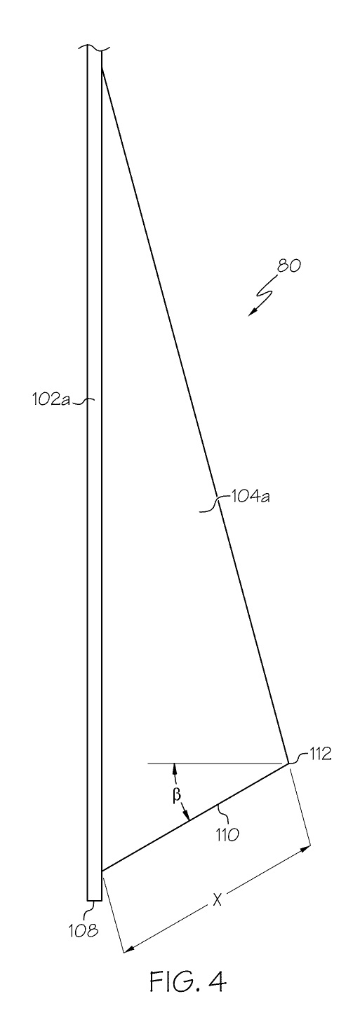

The edge director portion 100a and the edge director portion 100b extend generally toward one another and are connected together at the root 76 of the forming wedge portion 62. In particular, the flow directing portion 104a and the flow directing portion 104b extend toward one another to meet at an immersion edge 110. The immersion edge 110 extends outwardly from the flow blocking portion 102 to an immersion point 112. Referring also to FIG. 4, the immersion edge 110 can have both a horizontal and a vertical component, extending downwardly from the immersion point 112 to the flow blocking portion 102. Thus, the immersion edge 110 may affect the shape of the root line from a straight, horizontal root line portion to a root line having down turned, linear edges, as represented by dotted line 114 in FIG. 2. In some embodiments, the immersion edge 110 may be arranged at an angle β between about 10 degrees to about 45 degrees from horizontal (or the root 76). A length X of the immersion edge 110 between the immersion point 112 and bottom 108 of the flow blocking portion 102 may be between about 5 cm and about 15 cm.

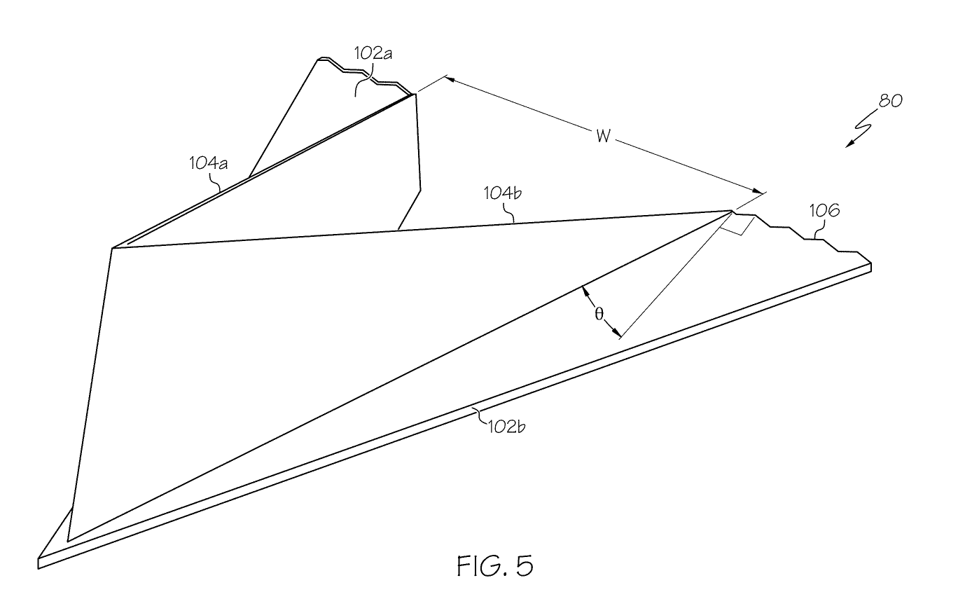

Referring to FIG. 5, the flow directing portions 104a and 104b extend toward one another to form a V-shape that is sized to receive the downwardly inclined forming surface portions 66 and 68 of the forming vessel 60 (FIG. 2). In some embodiments, the flow directing portions 104a and 104b may extend toward each other at flow direction angles θ from vertical. In some embodiments, the flow direction angles θ may be the same and between about 10 degrees and about 25 degrees, such as about 17.6 degrees and constant along the entire height of the flow directing portions 104a and 104b. The size of the flow direction angle θ depends, at least in part, on the width of the downwardly inclined forming surface portions 66 and 68. In some embodiments, a width W at the top 106 of the flow directing portions 104a and 104b may be between about 12 cm and about 30 cm.

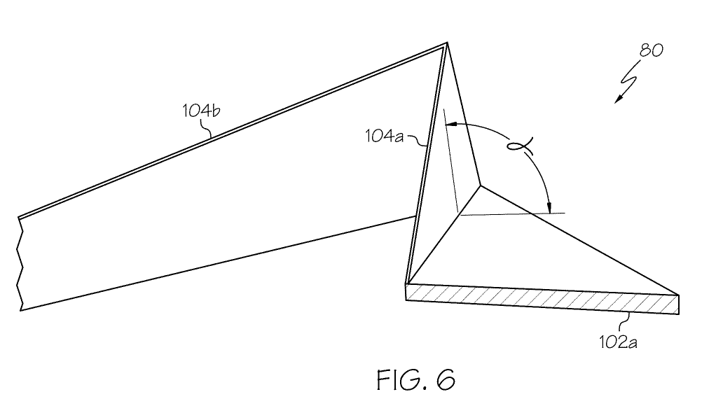

As can be appreciated by FIGS. 3-5, the flow directing portions 104a and 104b are both planar (i.e., without any curves) and extend outwardly from their respective flow blocking portions 102a and 102b. Referring briefly to FIG. 6, the flow directing portions 104a and 104b may extend outwardly from their respective flow blocking portions at oblique cross-flow direction angles α from their respective flow blocking portion 102a, 102b, thereby providing flow directing portions 104a and 104b. In some embodiments, the cross-flow direction angles α of the flow directing portions 104a and 104b may be the same and between about 95 degrees and about 105 degrees and constant along an entire height of the flow directing portions 104a and 104b.

Referring again to FIG. 3, outer edges 120a and 120b of the flow blocking portions 102a and 102b extend along the surfaces 94 and 96 of the retaining blocks 90 and 92 (FIGS. 1 and 2). In the illustrated embodiment, the outer edges 120a and 120b may also extend at an angle τ to vertical to intersect at the immersion edge 110. The angles τ may be greater than the flow direction angles θ to provide some area of the flow blocking portions 102a and 102b to mount against the planar surfaces 94 and 96 of the retaining blocks 90 and 92, while also intersecting at the immersion edge 110. Providing the outer edges 120a and 120b with the angles τ can reduce areas of the flow blocking portions 102a and 102b compared to embodiments having vertical outer edges, which can reduce an amount of refractory material used to form the flow blocking portions 102a and 102b.

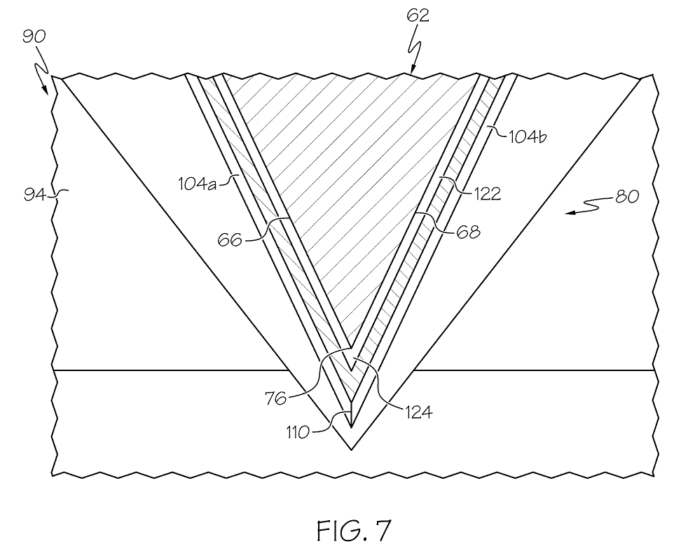

Referring to FIG. 7, a cross-section view of the forming wedge portion 62 illustrates the edge director 80 positioned on the forming wedge portion 62 and the planar surfaces 94 of the retaining block 90. The flow direction angles θ (FIG. 5) of the flow directing portions 104a and 104b can be selected to approach the off-vertical angles of the downwardly inclined forming surface portions 66, 68. Because of the cross-flow direction angles α, the flow directing portions 104a and 104b close a gap 122 provided between the downwardly inclined forming surface portions 66, 68 and the flow directing portions 104a and 104b. Also, because of the angle β (FIG. 4), the immersion edge 110 closes a gap 124 provided between the root 76 of the forming wedge portion 62 and the immersion edge 110.

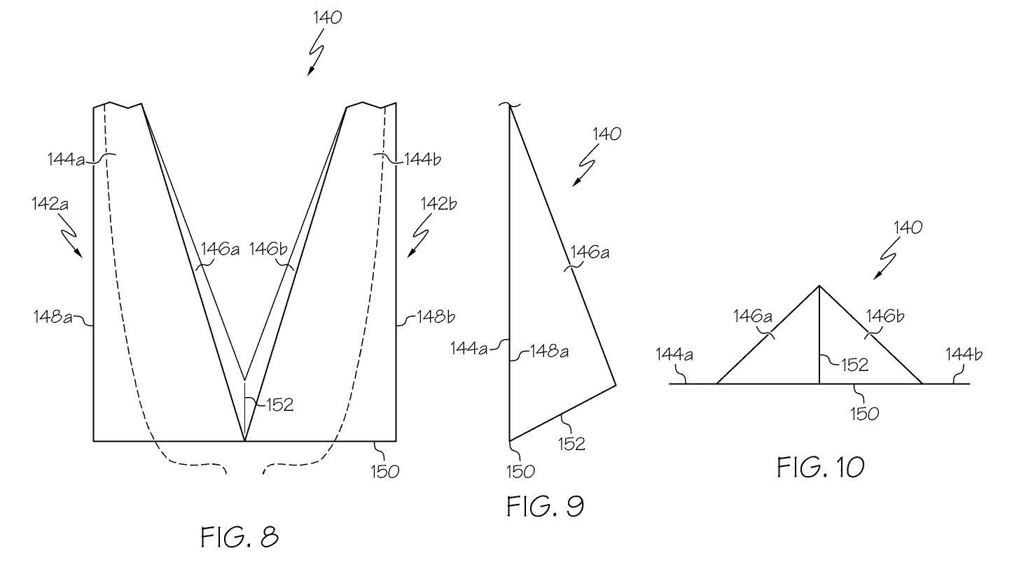

FIGS. 8-10 illustrate an alternative embodiment of an edge director 140 that includes many of the features described above with edge director 80 including edge director portions 142a and 142b with flow blocking portions 144a and 144b and flow directing portions 146a and 146b. The flow blocking portions 144a and 144b are generally planar and are shaped to extend alongside the surfaces 94 and 96 (FIGS. 1 and 2). The flow directing portions 146a and 146b extend outwardly from the flow blocking portions 144a and 144b and generally toward the downwardly inclined forming surface portions 66 and 68. In this embodiment, however, outer edges 148a and 148b are vertical and parallel, terminating at a bottom edge 150. The bottom edge 150 is located at (i.e., within about 13 mm or less, such as within 6 mm or less) of immersion edge 152. The vertical arrangement of the outer edges 148a and 148b can provide additional area of the flow blocking portions 144a and 144b against the surfaces 94 and 96 compared to edge director 80.

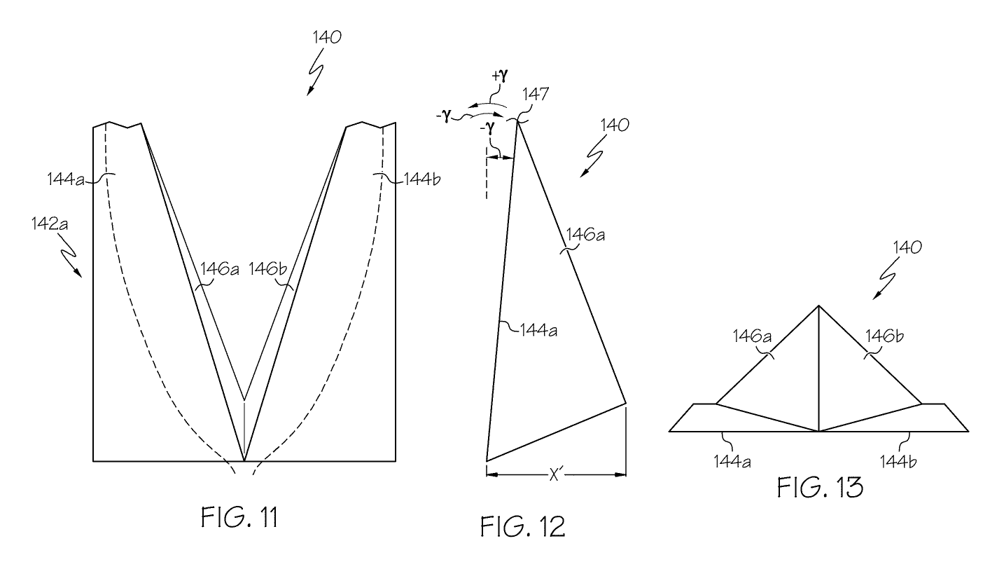

FIGS. 11-13 illustrate a negatively inclined orientation of the edge director 140 where the flow blocking portions 144 are inclined an angle γ (e.g., less than about 10 degrees, such as less than about eight degrees) relative to vertical. As used herein, the term “negatively inclined” refers to an angle resulting in an outward slope from top to bottom of the edge director 140 (away from a center of the forming vessel), thereby increasing a horizontal distance between opposing edge directors moving vertically toward the root line (see −γ of FIG. 12). “Positively inclined” refers to an angle resulting in an inward slope from top to bottom of the edge director 140 (toward the center of the forming vessel), thereby decreasing a horizontal distance between opposing edge directors moving vertically toward the root line (see +γ of FIG. 12). In these embodiments, the surfaces 94 and 96 may be inclined in a fashion similar to the edge director 140. The negatively inclined arrangement can provide a wider horizontal distance X′ (X′ is about 1.25X of FIG. 4) as bottom 145 of the edge director 140 is farther outboard than top 147. Glass flow that would otherwise flow straight down the flow blocking portions 144a and 144b in a vertical arrangement is instead urged toward the flow directing portions 146a and 146b and directed by the flow directing portions 146a and 146b toward the fusion plane. The glass flow then converges at the fusion plane at or above the root line, which can provide a thinner ribbon at edges of the glass flow since the edges of the glass flow is spread over a wider horizontal distance X′.

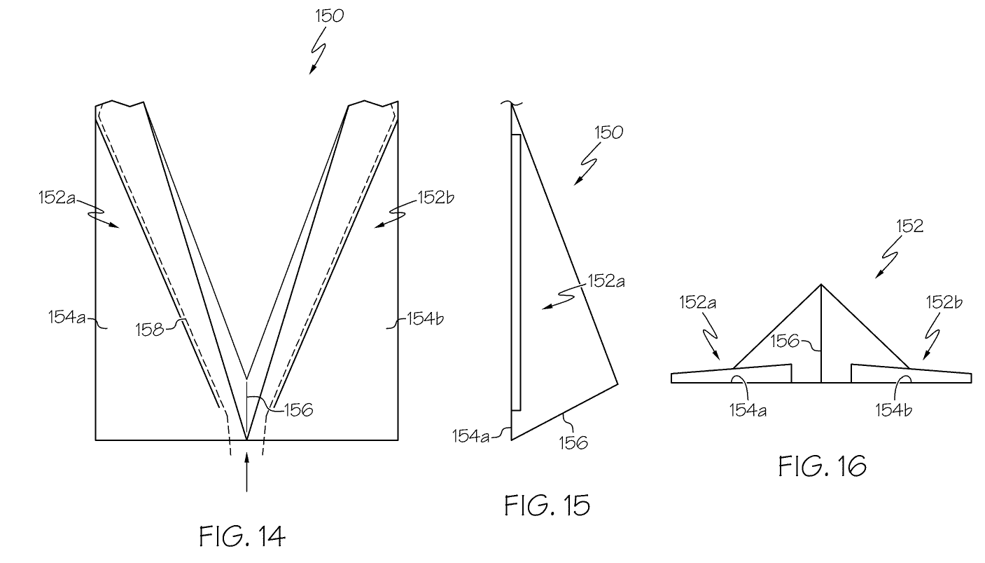

FIGS. 14-16 illustrate a variation of the edge director 140 where channel members 152a, 152b are provided as flow directing features. The channel members 152a and 152b extend along a height of the flow blocking portions 154a and 154b and extend toward each other at the immersion edge 156, decreasing a distance between the channel members 152a and 152b as they approach the immersion edge 156. The channel members 152a and 152b channel the glass flow from the flow blocking portions 154a and 154b toward the fusion plane. Dashed lines 158 represent an illustrative glass flow path illustrating edges of the glass flow converging at the root line.

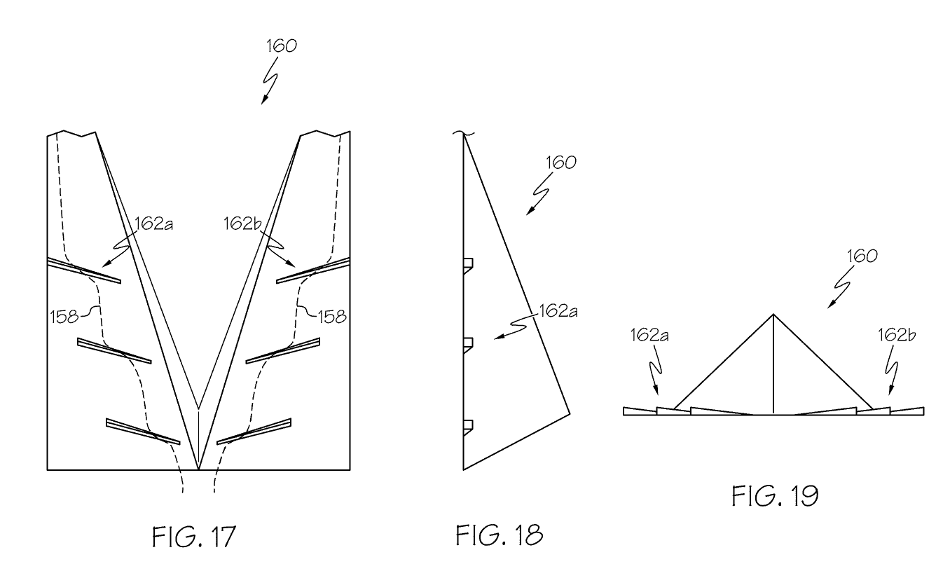

FIGS. 17-19 illustrate another variation of the edge director 140 where ledge members 162a and 162b are provided as a flow directing features to provide edge director 160. Where the channel members 152a and 152b of FIG. 14 may be sized to inhibit glass flow thereover, the ledge members 162a and 162b may be of reduced dimension (height) to allow flow thereover, while providing some guidance of the glass flow toward the fusion plane. Dashed lines 168 represent and illustrative glass flow path illustrating edges of the glass flow converging at the root line.

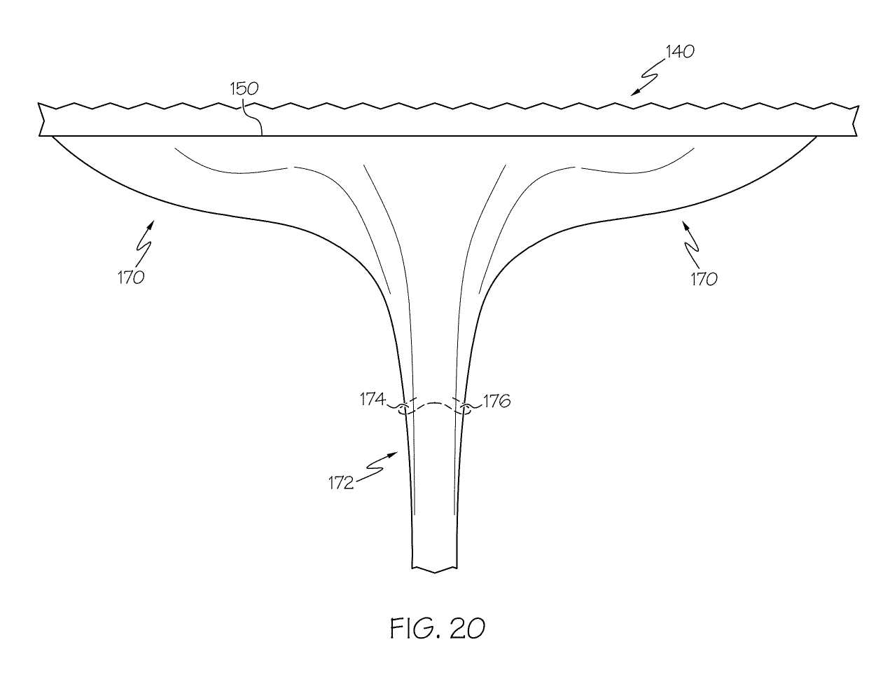

Referring to FIG. 20, an end view of the edge director 140 is shown in operation during a down draw process, such as that described above. While the operation is shown with regard to the edge director 140 of FIGS. 8-10, there may be variation in form of the material flow depending on shape characteristics of the particular edge director. As can be seen, lobes 170 of material flow are provided below the bottom edge 150 of the edge director 140 when viewed from the end of the edge director 140. These lobes 170 are oriented generally transverse to the fusion plane, thus rendering a T-shaped edge 172 immediately below the edge director 140. The ends 174 and 176 of the T-shape can move directly toward the fusion plane when a pulling force is applied and the ribbon edge becomes essentially fused with little residual T-shape.

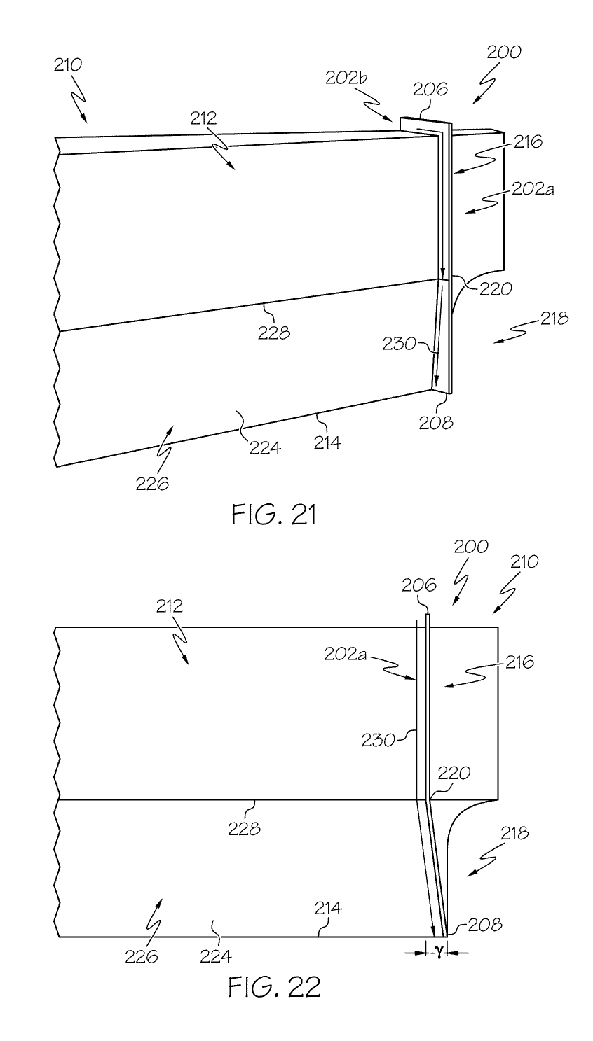

Referring to FIGS. 21 and 22, another embodiment of an edge director 200 is generally plate-like in shape that includes edge director portions 202a and 202b. As can be seen, the edge director portions 202a and 202b are formed as flow blocking portions 204a and 204b, without the flow directing portions described above. While the edge director 200 includes the edge director portions 202a and 202b, only edge director portion 202a can be seen and is described. It should be understood that edge director portion 202b may include the same features. Further, while only one edge director 200 is illustrated, another edge director may be located at an end of the forming vessel opposite the edge director 200. The edge director portion 202a may extend vertically from a top edge 206 located above an upper portion 212 of forming vessel 210 to a bottom edge 208 located at root 214.

The edge director portion 202a is divided into an upper portion 216 and a lower portion 218 that intersects the upper portion 216 at an intersection 220. The upper portion 216 extends vertically along a an outside surface portion 222 of the upper portion 212 and the lower portion 218 extends downwardly along an inclined forming surface 224 of forming wedge portion 226. The intersection 220 may be located at a break line or horizontal plane 228 dividing the upper portion 212 and the forming wedge portion 226. In some embodiments, the plane 228 may intersect the intersection 220.

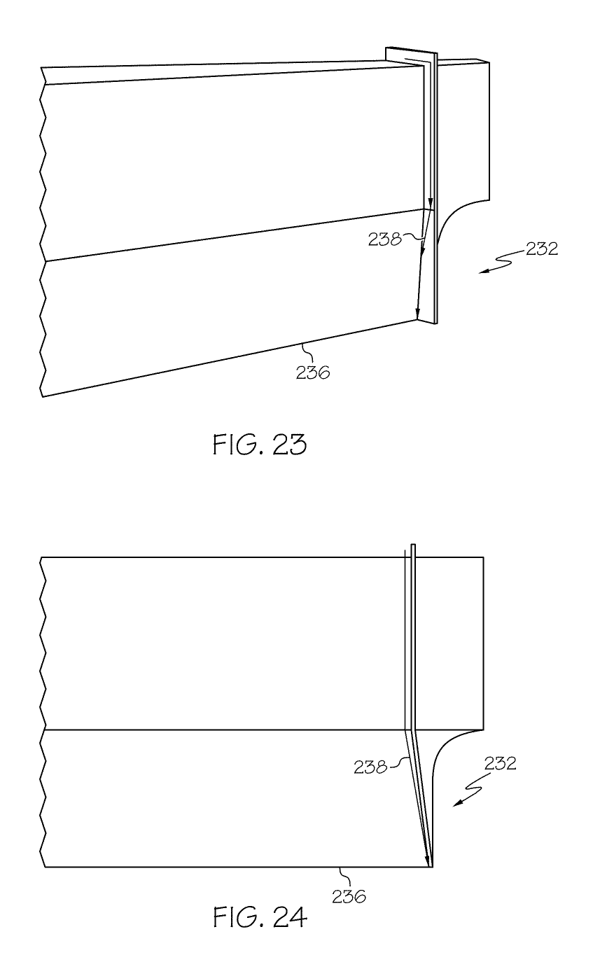

The lower portion 218 is negatively inclined at an angle −γ relative to vertical resulting in an outward slope extending from the intersection 220 to the bottom edge 208. The angle −γ can be limited to one half of a root angle σ defined between the inclined forming surfaces 224 of the forming wedge portion 226 (FIG. 2). In some embodiments the angle −γ may be about 10 degrees or less, such as between about five degrees and about 10 degrees, such as about eight degrees. Limiting the angle −γ to at or below 0.56 can improve control over the flow pattern such that the separate glass flows on opposite sides of the forming vessel 210 converge to the fusion plane slightly below the root 214, as represented by arrow 230. FIGS. 23 and 24 illustrate a lower portion 232 having a greater negatively inclined angle −γ providing a glass flow pattern where the glass flows converge to inclined forming surfaces 234 above root 236 represented by arrow 238.

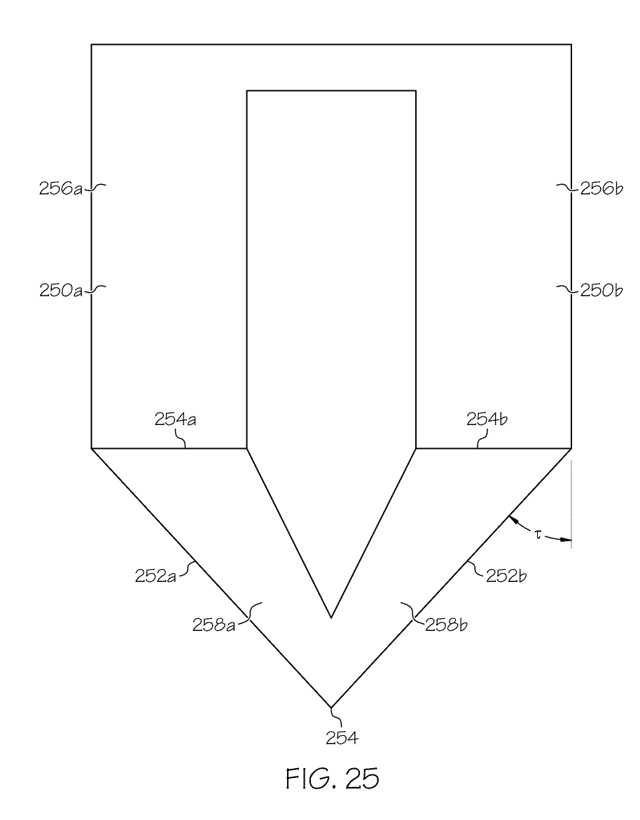

Referring to FIG. 25, an end view of a variation of the edge directors described with reference to FIGS. 21-24 includes flow blocking portions 250a and 250b including outer edges 252a and 252b. The outer edges 252a and 252b, rather than being vertical and parallel as illustrated by FIGS. 21-24, extend at an angle τ to vertical at intersections 254a and 254b between upper portions 256a and 256b and lower portions 258a and 258b to intersect at bottom 254. Providing the outer edges 252a and 252b with the angles τ can reduce areas of the flow blocking portions 250a and 250b compared to embodiments having vertical outer edges, which can reduce an amount of refractory material used to form the flow blocking portions 250a and 250b.

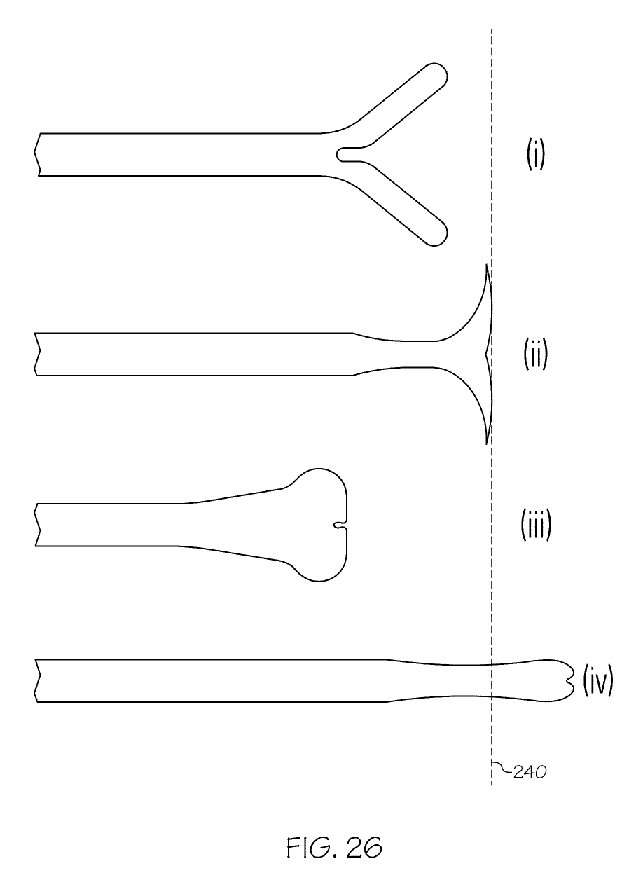

Referring to FIG. 26, section views of glass ribbon edges are illustrated resulting from use of various edge director structures. Line 240 represents an edge boundary at the upper portion as the molten glass enters the forming wedge portion. Examples (i)-(iii) illustrate various examples where no negative incline is present. Example (i) illustrates a Y-shaped glass ribbon edge flowing from an edge director with an edge directing portion. As can be seen, there is some width loss in Example (i). Example (ii) illustrates a vertical only flow blocking portion with no negatively inclined lower portion. As can be seen, the edges stop at the line 240 with flaring. Example (iii) represents no edge director at the forming wedge portion such that the glass flow has no flow blocking surface to travel along. Omitting the edge director at the forming wedge portion allows edges of the glass flow to flow towards the center of the forming vessel due to attenuation resulting in width loss. Example (iv) represents the negatively inclined lower portion, as described above with regard to FIGS. 21-24. Because the lower portion is negatively inclined, the glass ribbon widens as the glass flows toward the root and the edges are elongated with a resulting fused end edge with little to no Y-shape.

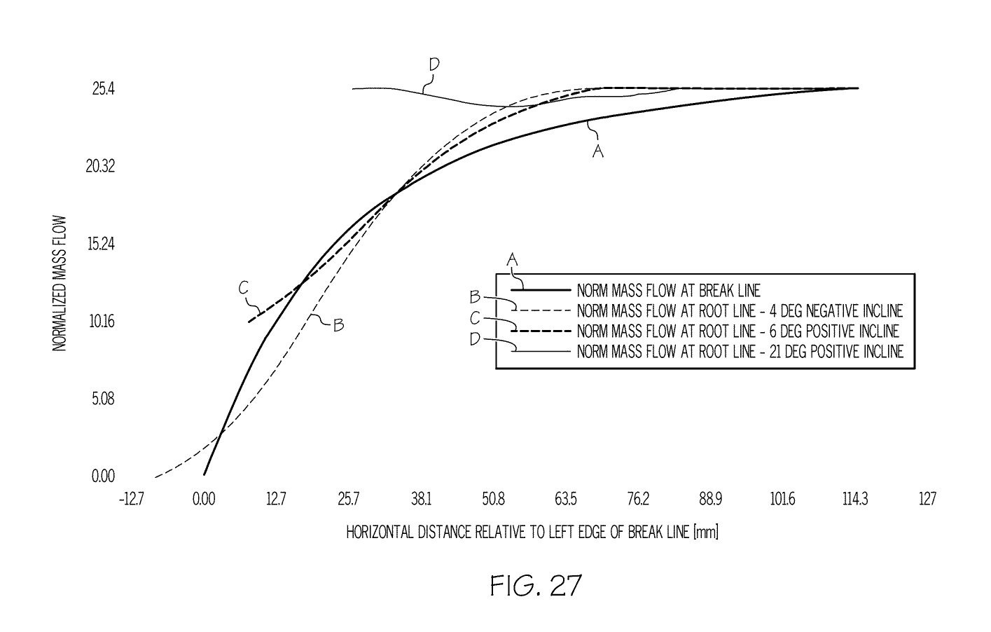

Referring to FIG. 27, a chart of normalized mass flow versus distance from the horizontal position 240 (at zero) along the width of the forming vessel of the upper portion is illustrated. Line A is the normalized mass flow for incoming molten glass flowing from the upper portion of the forming vessel and crossing the break line onto the forming wedge portion. Lines B-D represent mass flow crossing the bottom edge of the forming wedge portion. As represented by line A, mass flow crosses the break line outward to the origin zero edge position and increases from the zero edge position inward toward a center of the forming wedge portion until a relatively steady mass flow is reached. Relative to the incoming molten glass normalized mass flow shown by line A, the negatively inclined lower portion normalized mass flow represented by line B reduces mass flow over the initial 50 mm and increases mass flow over the next 50 mm. The negative incline of the lower portion provides mass flow outward beyond the zero position and as represented by Example (iv) above. As the inclination of the lower portion goes positive shown by lines C and D, a reduction of mass flow over the initial 50 mm from the zero position continues along with a reduction in overall glass ribbon width.

While the lower portions described with reference to FIGS. 21-24 are illustrated as being planar and angled along a line, the lower portions could be curved, multi-linear (multiple intersecting lower portions), etc. The termination point of the lower portions may be located below the root and the general shape can be any suitable shape.

The above-described edge directors can produce a fully fused edge at the start of the free ribbon boundary (i.e., the root line or bottom edge). The negatively inclined edge director can have an impact on edge thickness due to the ability to spread the typical amount of mass flow over a greater horizontal distance. Spreading the mass flow over a wider horizontal distance can also provide for a wider glass ribbon.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. An apparatus for downwardly drawing a glass ribbon comprising:
a forming vessel comprising:
an upper portion including a pair of outside surfaces; and
a forming wedge portion including a pair of downwardly inclined forming surfaces converging along a downstream direction to form a bottom edge; and
an edge director comprising a flow blocking portion including an upper portion extending along one of the pair of outside surfaces and a lower portion that extends along one of the pair of downwardly inclined forming surfaces and is negatively inclined relative to vertical, the lower portion of the flow blocking portion extending outwardly and downwardly from the upper portion of the flow blocking portion toward the bottom edge.

2. The apparatus of claim 1, wherein the upper portion of the forming vessel and the forming wedge portion are divided by a horizontal plane passing through the forming vessel.

3. The apparatus of claim 2, wherein the lower portion of the flow blocking portion begins at or below the horizontal plane.

4. The apparatus of claim 2, wherein the flow blocking portion includes an intersection at the horizontal plane connecting the upper portion of the flow blocking portion and the lower portion of the flow blocking portion.

5. The apparatus of claim 1, wherein the lower portion of the flow blocking portion is negatively inclined at an angle of no more than 10 degrees relative to vertical.

6. The apparatus of claim 1, wherein the lower portion of the flow blocking portion is negatively inclined an angle relative to vertical that is equal to or less than one half of an angle measured between the pair of inclined forming surfaces.

7. The apparatus of claim 1, wherein the edge director is a first edge director, the apparatus further comprising a second edge director at an opposite side of the forming vessel from the first edge director, the second edge director comprising a second flow blocking portion including an upper portion extending along one of the pair of outside surfaces and a lower portion extending along one of the pair of downwardly inclined forming surfaces and is negatively inclined relative to vertical, the lower portion of the second flow blocking portion extending outwardly and downwardly from the upper portion of the second flow blocking portion toward the bottom edge.

8. The apparatus of claim 7, wherein a horizontal distance between the first edge director and the second edge director increases along a height of the forming wedge portion toward the bottom edge.

9. An apparatus for downwardly drawing a glass ribbon comprising:
a forming vessel including a pair of downwardly inclined forming surface portions converging along a downstream direction to form a bottom edge; and
an edge director comprising a flow blocking portion that extends outwardly from at least one of the downwardly inclined surface portions and a flow directing portion that engages both the flow blocking portion and the at least one of the downwardly inclined surface portions;
wherein a cross-flow direction angle of the flow directing portion is provided a constant preselected angle α to the flow blocking portion between about 95 degrees and about 105 degrees to provide a planar flow directing portion.

10. The apparatus of claim 9, wherein a flow direction angle of the flow directing portion is provided a constant preselected angle θ to vertical between about 10 degrees and about 25 degrees to provide the substantially planar flow directing portion.

11. The apparatus of claim 9, wherein the edge director including the flow directing portion and the flow blocking portion terminate at an immersion edge.

12. The apparatus of claim 11, wherein the immersion edge is offset an angle β from horizontal of between about 10 degrees and about 45 degrees.

13. The apparatus of claim 9, wherein the edge director includes a bottom edge, the flow blocking portion extending from a top to the bottom edge of the edge director.

14. The apparatus of claim 9, wherein the flow blocking portion is positioned vertically.

15. The apparatus of claim 9, wherein the flow blocking portion is offset an angle γ from vertical.

16. The apparatus of claim 15, wherein the flow blocking portion is offset from vertical an angle γ of no more than about 10 degrees.

17. The apparatus of claim 9 further comprising a flow directing feature extending outwardly from the flow directing portion that directs glass flow toward the flow directing portion.

18. The apparatus of claim 9, wherein the flow blocking portion and the flow directing portion form a first edge director portion of the edge director, the edge director comprising a second edge director portion comprising a flow blocking portion that extends outwardly from the other of the at least one of the downwardly inclined surface portions and an flow directing portion that engages both the flow blocking portion of the second edge director portion and the other of the at least one of the downwardly inclined surface portions.

19. The apparatus of claim 18, wherein a cross-flow direction angle of the flow directing portion of the second edge director portion is provided a constant preselected angle α to the flow blocking portion of the second edge director portion between about 95 and about 105 to provide a planar oblique flow directing portion of the second edge director portion.
